(19) United States
(12) Patent Application Publication
(10) Pub. No.: US 2025/0259087 A1
(43) Pub. Date: Aug. 14, 2025

(54) Reconfigurable Quantum Arrays and Quantum Memory for Learning

(71) Applicant: Google LLC, Mountain View, CA (US)

(72) Inventors: Jarrod Ryan McClean, Underwood, WA (US); Hsin-Yuan Huang, Pasadena, CA (US); Michael Blythe Broughton, Santa Barbara, CA (US)

(21) Appl. No.: 19/048,434

(22) Filed: Feb. 7, 2025

Related U.S. Application Data
(60) Provisional application No. 63/551,786, filed on Feb. 9, 2024.

(51) Int. Cl. G06N 10/20; G06N 10/70

(52) U.S. Cl. CPC G06N 10/20; G06N 10/70

(57) ABSTRACT

A quantum system can include a reconfigurable array of quantum sensors; and one or more processors configured to perform operations, the operations including: configuring the quantum system including the reconfigurable array of quantum sensors; obtaining a signal from a quantum sensor exposed to a signal for a period of time; transducing at least one state of the quantum sensor into quantum memory; encoding the at least one transduced state using an error-correcting code; processing the encoded states by quantum operations to extract at least one measurement value; and processing the extracted at least one measurement value to determine one or more classical values.

### PRIORITY CLAIM

The present application claims the benefit of priority of U.S. Provisional Application Ser. No. 63/551,786 filed on Feb. 9, 2024, titled “Reconfigurable Quantum Arrays and Quantum Memory for Learning,” which is incorporated herein by reference.

### FIELD

The present disclosure relates generally to quantum computing systems and more particularly to reconfigurable quantum arrays and quantum memory for learning.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0>+b |1> The “0” and “1” states of a digital computer are analogous to the |0>and |1> basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The computer-implemented method includes configuring a quantum system including a reconfigurable array of quantum sensors. The computer-implemented method includes obtaining a signal from a quantum sensor of the reconfigurable array of quantum sensors, the quantum sensor exposed to a signal for a period of time. The computer-implemented method includes transducing at least one state of the quantum sensor into quantum memory. The computer-implemented method includes encoding the at least one transduced state using an error-correcting code. The computer-implemented method includes processing the encoded states by quantum operations to extract at least one measurement value. The computer-implemented method includes processing the extracted at least one measurement value to determine one or more classical values.

In some implementations, the reconfigurable array of quantum sensors includes one of a 1D lattice, a 2D lattice, a 3D lattice, or an irregular configuration.

In some implementations, the reconfigurable array includes one or more Rydberg atoms having adjustable frequencies.

In some implementations, the reconfigurable array includes mixed sensor media across the reconfigurable array, the mixed sensor media including one or more of an atom, a nitrogen vacancy, a silicon vacancy, a mechanical resonator, an optical resonator, an optical cavity, an electromagnetic cavity, or a superconducting sensor.

In some implementations, the quantum system includes one or more control elements for configuring the quantum sensor for collecting the signal.

In some implementations, the quantum memory includes a different substrate from the quantum sensor.

In some implementations, the quantum operations for processing the encoded states to extract at least one measurement value include one or more of Bell measurements, generalized Bell measurements, shadow tomography, multiplicative weight updates, or quantum measurements across one or more copies of the encoded states.

In some implementations, the one or more classical values relate to one or more of gravity detection, mineral discovery, baseline interferometry, detection of axions, supplementation of data in machine learning models addressing quantum systems, detection schemes on quantum communication networks, or data prediction.

In some implementations, the quantum sensor observes a target system while exposed to the signal, and wherein the quantum sensor is dependent on a parameter of interest reflective of a state of the target system while observing the target system.

In some implementations, the target system includes one or more of an unknown metabolite and wherein the parameter of interest includes a structure of the unknown metabolite.

In some implementations, the parameter of interest includes one or more of an amount, a distribution, a type, or a material property of matter in an interior of the target system.

In some implementations, the quantum sensor includes a plurality of quantum sensors that probe the target system in parallel.

In some implementations, the quantum sensor includes a at least one of nitrogen vacancy in diamond, a hyper-polarized spin in gases, a nuclear spin of chemical specials in a solution, or a cavity mode for sensing photonic states or detecting exotic particles.

In some implementations, encoding the at least one transduced state includes encoding the at least one transduced state in a quantum buffer.

In some implementations, the quantum buffer includes one or more of a superconducting computer including one or more superconducting qubits, an ion trap quantum computer, or a quantum computer that includes photonic qubits in a cluster state.

In some implementations, the quantum sensor and the quantum buffer operate at different energy scales.

Another example aspect of the present disclosure provides for a quantum system. The quantum system includes a reconfigurable array of quantum sensors. The quantum system includes a quantum memory. The quantum system includes one or more processors and one or more non-transitory, computer-readable media storing instructions that, when implemented, cause the one or more processors to perform operations. The operations include obtaining a signal from a quantum sensor of the reconfigurable array of quantum sensors, the quantum sensor exposed to a signal for a period of time. The operations include transducing at least one state of the quantum sensor into the quantum memory. The operations include encoding the at least one transduced state using an error-correcting code. The operations include processing the encoded states by quantum operations to extract at least one measurement value. The operations include processing the extracted at least one measurement value to determine one or more classical values.

In some implementations, the quantum sensor observes a target system while exposed to the signal, and wherein the quantum sensor is dependent on a parameter of interest reflective of a state of the target system while observing the target system.

In some implementations, the quantum buffer includes one or more of a superconducting computer including one or more superconducting qubits, an ion trap quantum computer, or a quantum computer that includes photonic qubits in a cluster state.

Another example aspect of the present disclosure provides for one or more non-transitory, computer-readable media storing instructions that, when implemented, cause one or more processors to perform operations. The operations include configuring a quantum system including a reconfigurable array of quantum sensors. The operations include obtaining a signal from a quantum sensor exposed to a signal for a period of time. The operations include transducing at least one state of the quantum sensor into quantum memory. The operations include encoding the at least one transduced state using an error-correcting code. The operations include processing the encoded states by quantum operations to extract at least one measurement value. The operations include processing the extracted at least one measurement value to determine one or more classical values.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure.

FIG. 2 depicts an example quantum computing system according to example embodiments of the present disclosure.

FIG. 3 depicts an example quantum computing system according to example embodiments of the present disclosure.

FIG. 4 depicts a flow chart of an example method according to example embodiments of the present disclosure.

FIG. 5 depicts a block diagram of an example computing system according to example embodiments of the present disclosure.

### DETAILED DESCRIPTION

Example aspects of the present disclosure are directed to systems, devices, and computer-implemented methods for quantum computing systems. More particularly, example aspects provide an approach to use quantum computers to extract information from quantum states in the physical world, such as, for example, arrays of quantum sensors or emitters. Examples of this technology include the combination of quantum memory (both minimal and non-minimal) and quantum sensor arrays with reconfigurable elements and arrangements. This approach may provide for the extraction of information from sensors with an exponential advantage when compared to the same tasks without a quantum computer.

One example implementation of the present disclosure is outlined below. Based on the target phenomenon of interest, a spatial or temporal arrangement of quantum sensors is designed using a reconfigurable array. A quantum sensor can be any quantum system capable of controlled interaction and readout that may be interfaced to another quantum system coherently. This arrangement may be regular, such as in a 1D, 2D, or 3D lattice, or irregular depending on the optimal configuration for the given task. The scales may range from very small (e.g. nanometers) to very large (miles, interplanetary, or intergalactic using quantum entanglement connections). Each individual element in the array may be chosen custom or tuned custom for the design. For example, neutral (Rydberg) atoms can be tuned to frequencies ranging from MHz to THz to optical absorption. This array may be combined with optical or general electromagnetic control elements to collect signals in ideal configurations collecting multiple copies either simultaneously or in sequence after transduction.

The quantum sensor may be exposed to the desired signal for the prescribed time and the signal is collected in the quantum sensor. The quantum state of the sensor is then transferred into quantum memory, which may be of a different or similar physical substrate as the sensor. This process is referred to herein as transduction. The transduced state is encoded into quantum memory using an error correcting code. This code may range from the identity (physical encoding) to advanced high distance or rate encoding designed for long term storage based on the required lifetime and quality of the state. The above process of collection, transduction, and encoding is repeated as needed until a sufficient number of copies of the state are collected for processing. This may be as few as 2 states for minimal quantum memory processing, where the method is repeated destructively without growing the memory beyond some constant number of copies k. In some implementations, the configuration of the above may be reversed to act as a quantum emitter if needed.

The states in memory are processed using quantum computation in combination with the quantum memory and measurement to extract the desired data from the stored states. This may range from Bell measurements, to generalized Bell measurements, to shadow tomography, multiplicative weight updates, or more general quantum measurements across one or more copies stored in memory. The extracted measurements are stored classically and processed to determine the values of interest for the sensor.

In particular, aspects of the present disclosure provide for the combination of quantum sensors arrays with quantum memory, which is defined as the ability to hold one or more states of the size of the sensor in a quantum computing device. In addition, aspects of the present disclosure provides for the use of reconfigurable arrays of Neutral Atoms (Rydberg Atoms) to construct such an array in space, in time, or both. Furthermore, aspects of the present disclosure provide for the use of adjustable frequencies of Rydberg atoms throughout the array to target specific phenomena. The present disclosure additional provides the use of mixed sensor media across the array, including but not limited to atoms, nitrogen vacancies, silicon vacancies, mechanical resonators, optical resonators, optical cavities, electromagnetic cavities, and superconducting sensors. The present disclosure additionally relates to a combination of array state transduction with quantum error correction to allow long term and accurate quantum data processing, and the use of generalized quantum memory measurements such as Bell measurements over sensor array states stored in quantum memory, as well as use of the array setup in reverse to act as a quantum emitter.

The applications of the present disclosure include characterizations of unknown quantum states, such as those in the proprietary quantum devices, as well as characterizing information about physical quantum sensor arrays or cavities. The applications of the present disclosure additionally include, but are not limited to, gravity detection and imaging through opaque objects, including mineral discovery, very long baseline interferometry for enhancement of optical imaging of astronomical objects including planets and asteroids, detection of axions and other high energy physics phenomena, supplementation of data in machine learning models addressing quantum systems, novel detection schemes on quantum communication networks, and prediction using data from generic quantum sensors or technology. The present disclosure additionally opens up wide new application opportunities for quantum computers to effectively interface with other quantum technologies.

Systems and methods according to example aspects of the present disclosure can provide for a number of technical effects and benefits, including but not limited to improvements to computing technology (e.g., quantum computing technology). For instance, example aspects of the present disclosure can provide for an exponential improvement in efficiency of extracting data from sensors compared to similar approaches not utilizing a quantum computer according to the present disclosure.

With reference now to the Figures, example embodiments of the present disclosure will be discussed in further detail.

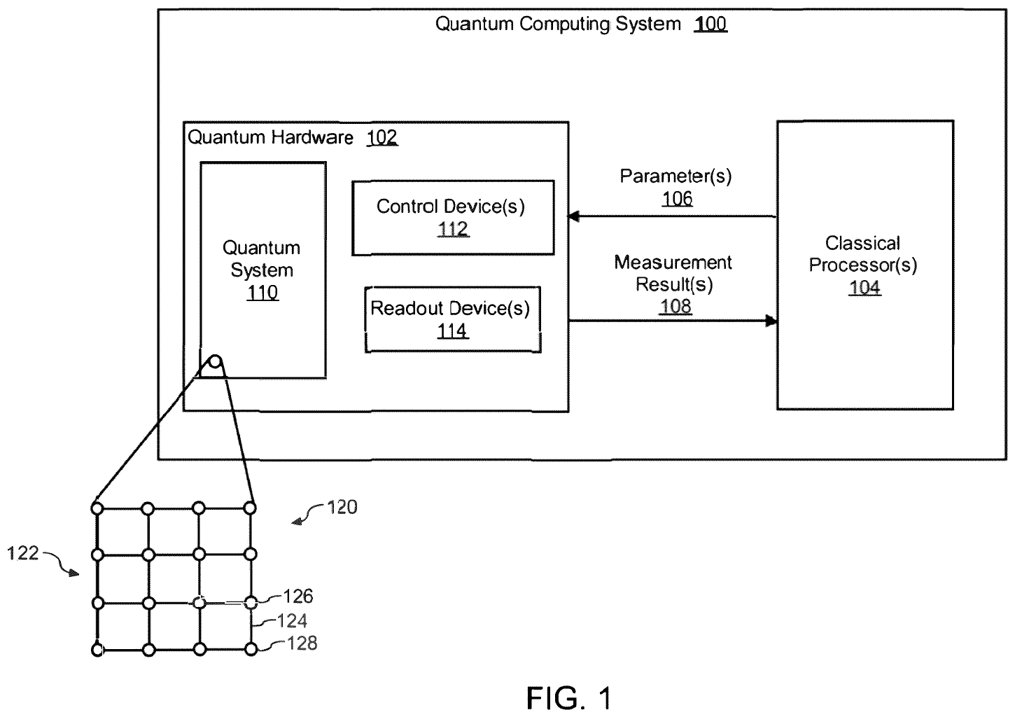

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like. In some implementations, the superconducting qubits may be located in a cryostat to cool the qubits to superconducting temperatures (e.g., less than about 3 Kelvin). However, aspects of the present disclosure are not limited to superconducting qubits. In some examples, any suitable qubit structure may be used without deviating from the scope of the present disclosure, such as photonic qubits, trapped ion qubits, spin qubits, neutral atom qubits, quantum dot qubits, molecular qubits, or other qubits.

The type of multi-level quantum subsystems that the system 100 utilizes may vary. For example, in some cases the system may include one or more readout device(s) 114 coupled (e.g., electromagnetically coupled) to one or more qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dot, or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to control the qubits. For example, in some implementations the multi-level quantum subsystems may be neutral atom qubits and the control devices 112 may be configured to provide control pulses to control lines to generate magnetic fields to control the qubits.

The quantum hardware 102 may further include readout devices 114 (e.g., readout resonators). Measurement results 108 obtained via readout devices 114 may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. The readout device(s) 114 may be configured to perform quantum measurements on the quantum system 110 and send measurement results 108 to the classical processors 104.

In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0> and |1> states of an element of the quantum system, such as a qubit, to measure the state of the element (e.g., the qubit). For example, the resonance frequency of a readout resonator can take on different values when a qubit is in the state |0> or the state |1>, due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed. In some examples, the operating of the frequencies for the qubits 120 may be adjusted using AC Stark shift according to examples of the present disclosure before a quantum computation, quantum gate, and/or a quantum algorithm is performed.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

FIG. 1 depicts one example quantum computing system that can be used to implement the methods and operations according to example aspects of the present disclosure. Other quantum computing systems can be used without deviating from the scope of the present disclosure.

FIG. 1 depicts one example quantum computing system that can be used to implement the methods and operations according to example aspects of the present disclosure. Other quantum computing systems can be used without deviating from the scope of the present disclosure.

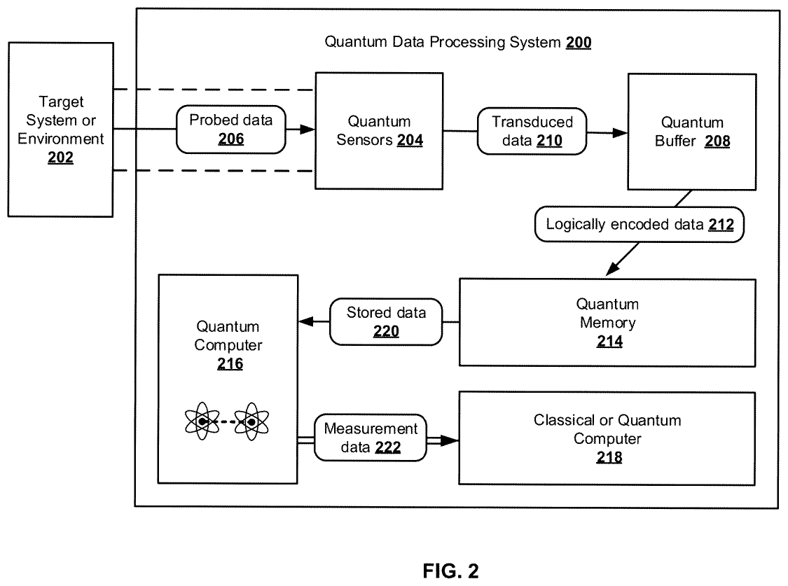

FIG. 2 is a block diagram of an example quantum data processing system 200 for performing the presently described quantum-enhanced data processing techniques. The example quantum data processing system 200 is an example of a system implemented as classical and quantum computer programs on one or more classical computers and quantum computing devices in one or more locations, in which the systems, components, and techniques described herein can be implemented.

The example quantum data processing system 200 includes one or more quantum sensors, e.g., quantum sensor 204, a quantum buffer 208, quantum memory 214, quantum computer 216 and a classical or quantum computer 218. The quantum sensors are quantum devices that are configured to probe respective target systems, e.g., target system 202, and collect data 206 from the target systems. The target system 202 is a system of interest, e.g., a system from which physical quantities or parameters are to be estimated, and can vary based on the quantum data processing task being performed by the system 200. The target system 202 and the physical quantities or parameters can be quantum or classical. For example, data collected by the quantum sensor 204 could be produced by a classical process. In these cases by implementing the techniques described in this specification, properties of such a classical process can be determined exponentially faster-even though the source data is classical.

To probe the target system 202, a quantum sensor 204 interacts with the target system 202 and the quantum state of a quantum system included in the quantum sensor 204 (hereafter referred to as a quantum state of the quantum sensor 204) evolves for a predetermined sensing time. During the evolution, the state of the quantum sensor 204 becomes dependent on the physical quantity or parameter of interest and reflects the state of the target system 202. In this manner, the quantum sensor 204 collects data 206 from the target system 202, where the data 206 is the evolved quantum state of the quantum sensor 204. In some implementations the data 206 can be collected with finite signal to noise ratio. In some implementations the quantum sensor 204 can implement full or partial quantum error correction to improve its sensing or data retention capabilities. In some implementations the quantum sensor 204 can maintain quantum coherence.

The type of quantum sensor 204 included in the quantum data processing system 200 is dependent on the target system 202 and the physical quantities or parameters of interest. For example, in magnetometry, electrometry, thermometry and chemical sensing applications the quantum sensor 204 can be a solid-state quantum sensor that includes nitrogen vacancies in a diamond (either isolated or distributed in a network). Other example quantum sensors include hyper-polarized spins in gases, nuclear spins of chemical specials in a solution, or cavity modes used to sense photonic states or detect exotic particles.

As a specific example, in some implementations the target system 202 can be an unknown metabolite and the physical quantities/properties can be the unknown metabolite's structure. In this example the structure of the unknown metabolite can be determined through signatures related to spin magnetization, electronic or vibrational excitation, or charge transport and the quantum sensors can include hyperpolarized gases compatible with spin transport, nitrogen vacancies in diamonds with enough for spatial resolution, or nanomechanical sensors for vibrational measurements.

As another example, in some implementations the target system can be some system for which a density profile of an unknown interior of the system is to be determined, e.g., imaging inside a cavern, container, or building. In this example the physical quantities to be determined can include an amount, distribution, and type of matter as well as material properties such as density or rigidity, and the quantum sensors can include quantum sensors sensitive to gravitational effects, e.g., advanced atom interferometers or atomic fountains that use quantum effects to sense gravity between the different spatial locations of the atoms. The quantum data processing system can increase the sensitivity and capabilities of these sensors.

In some implementations the system can include multiple quantum sensors that probe the target system 202 in parallel. Probing the target system 202 in parallel using multiple quantum sensors can decrease the amount of time that the state is kept in memory and increase the sampling rate, particularly in cases where sensing is being performed on multiple copies of a same target system, e.g., many copies of a molecule. Alternatively or in addition, the multiple quantum sensors can include different types of quantum sensors. Collecting complementary data from different types of sensors, e.g., in parallel, can increase the power of the quantum data processing system, e.g., enable the system to extract more accurate and insightful information and therefore compute improved estimations of physical properties and parameters, and is made possible by the structure and workflow of the quantum data processing system.

In conventional quantum data processing systems, i.e., systems different to the quantum data processing system described in this specification, after the quantum state of the quantum sensor 204 evolves for the predetermined sensing time and collects data 206 from the target system, the evolved quantum state of the quantum sensor 204 would be measured. The target system 202 would be repeatedly probed by the quantum sensor 204 during a total available measurement time and an estimate of the physical quantity or parameter of interest would be inferred via classical computation from accumulated measurement data. Accordingly, quantum information is destroyed early in the process, making subsequent data purification/extraction or data processing exponentially costly in the number of probes.

To avoid these costs, the quantum data processing system 200 transfers the data 206 collected by the quantum sensor 204 to the quantum buffer 208. The quantum buffer 208 is a quantum computing device that is configured to logically encode quantum information. For example, the quantum buffer 208 can be a superconducting computer that includes superconducting qubits, an ion trap quantum computer or a quantum computer that includes photonic qubits in a cluster state.

Since the quantum sensor 204 and quantum buffer 208 can be different quantum devices that include different quantum media, the devices can operate at different energy scales. For example, in some implementations the quantum sensor 204 can provide data as a state in a bosonic cavity mode whereas the quantum buffer 208 can include superconducting qubits. Therefore, to transfer the data 206, the quantum data processing system 200 is configured to perform quantum transduction on the data 206 collected by the quantum sensor 204 to convert the data 206 to transduced data 210 in a suitable form.

The particular transduction performed by the quantum data processing system 200 is dependent on the type of quantum sensor 204 and quantum buffer 208 included in the quantum data processing system 200 and can vary. For example, the quantum data processing system 200 can perform microwave to optical transduction to transform the data from an optical photon state of the quantum sensor 204 to a superconducting quantum state of the quantum buffer 208. As another example the quantum data processing system 200 can perform optical to ion transduction for an ion trap quantum buffer, cavity mode to superconducting qubit transduction for a superconducting quantum buffer, or cavity mode to photonic qubit transduction for a quantum buffer that includes photonic qubits in cluster states. In some implementations the transduction can be performed with limited fidelity.

In some implementations the quantum data processing system 200 logically encodes the transduced data 210 in the quantum buffer 208 into a quantum error correcting code to generate logically encoded data 212. Logically encoding the transduced data 210 accommodates storage of multiple copies of probed data and subsequent computation on the probed data. In some implementations the quantum data processing system 200 can logically encode the transduced data 210 through application of a unitary encoding circuit or a state injection technique. In these implementations the logical encoding can have a fidelity that is limited by the computational operations performed to apply the unitary encoding circuit or state injection technique.

The quantum memory 214 is configured to store logically encoded data 212 obtained from the quantum buffer 208. In some implementations, e.g. where computational resources are limited, the quantum error correcting code can be the quantum buffer itself. Example logical encodings and quantum storage systems that can be implemented by the quantum data processing system 200 include unitary encoding into the surface code, state injection into the surface code, encoding or injection into quantum LDPC codes directly, injection into a surface code followed by injection into an LDPC or higher rate code, or direct transfer from a logical sensor into a logical code state. The quantum memory may, for example, be an optical quantum memory, such as a cavity-based quantum memory or media-based quantum memory (e.g. atomic-, ionic- or molecular-based memories). It will be appreciated that many examples of quantum memory may alternatively be used.

In some implementations the distance of the code used by the quantum data processing system can be determined by subsequent computations to be performed on the data, e.g., by the quantum computer 216 as described below, and/or an expected wait time required to store a sufficient number of state copies in the quantum memory 214. For example, the code distance can be determined by the wait time to receive copies of the quantum state for a given protocol in addition to the computational time required, e.g., if 10 copies of the quantum state are required and it is expected that a computation takes a certain amount of time, the physical error rate in the device along with the threshold in the code can be used to calculate a required code distance from these factors to safely ensure that information does not decay inside the computer on that timescale and with those operations. In some implementations the code distance d can scale as d \tilde{ }log (expected wait time+computation time).

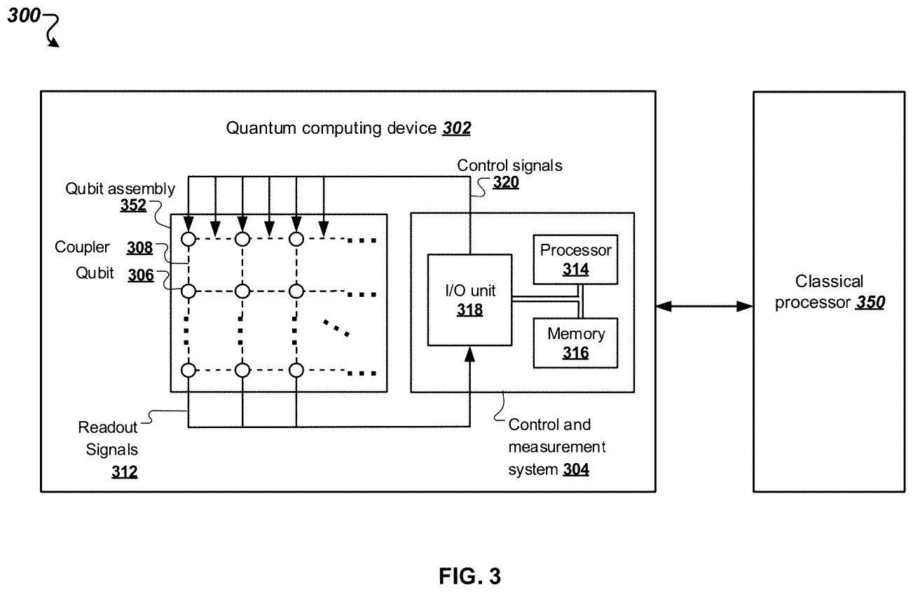

The quantum memory 214 is configured to store logically encoded data 212 obtained from the quantum buffer 208. For example, as described in more detail below with reference to FIG. 3, the quantum data processing system 200 can repeatedly probe the target system 202 to collect multiple copies of the evolved quantum state of the quantum sensor 204 (in this specification a copy of the evolved quantum state is understood to mean a quantum state obtained after the quantum sensor 104 is reset and/or initialized and interacts with the target system 102 for the predetermined sensing time to obtain an evolved quantum state of the quantum sensor.) Each copy can be transduced and logically encoded before being stored in the quantum memory 214.

Once a predetermined number of copies of the evolved quantum state of the quantum sensor 204 is stored in the quantum memory 214, the stored data 220 can be loaded into the quantum computer 216 for processing. The predetermined number of copies is dependent on the operations to be performed on the data by the quantum computer 216 and can vary.

The quantum computer 216 is configured to process the data received from the quantum memory 214, e.g., through application of quantum algorithms. In some implementations the quantum computer 216 can purify the data received from the quantum memory 214. For example, the quantum computer can perform quantum data extraction on the data using linear distillation technique, e.g., quantum state distillation, virtual state distillation, or a quantum principle component analysis method (qPCA). The data extraction step achieves an exponential advantage over classical methods in the number of copies that needed to be recorded to perform this extraction. An example quantum computer 314 for processing data received from the quantum memory 214 is described below with reference to FIG. 3.

The quantum data processing system 200 can perform measurements on the extracted quantum data to obtain measurement data 222 and extract relevant information. The measurement data 222 can be provided to the classical or quantum computer 216 for further analysis, e.g., to estimate the physical quantities or parameters of interest. In some implementations the extracted information can be provided as input to a quantum machine learning system included in the classical or quantum computer 218 to learn properties about the data. In FIG. 2 the classical or quantum computer 216 is shown as a separate device to the quantum computer 216, however in some implementations the system 200 can include one computing device configured to perform the operations described above with reference to quantum computer 216 and classical or quantum computer 218.

In some implementations the quantum data processing system 100 can be included in or applied to a communication or quantum internet setting. For example, the quantum data processing system 200 can operate on data received from a quantum internet, quantum network, or quantum repeater along a quantum network. In these implementations, quantum communication protocols can also be included. In these settings the quantum data processing system 200 can be used to recover from errors with additional effectiveness beyond the code distance of original messages.

FIG. 3 depicts an example classical/quantum computer 300 for performing some or all of the classical and quantum operations described in this specification, e.g., the operations described above with reference to quantum computer 216 and classical or quantum computer 218. The example classical/quantum computer 300 includes an example quantum computing device 302. The quantum computing device 302 is intended to represent various forms of quantum computing devices. The components shown here, their connections and relationships, and their functions, are exemplary only.

The example quantum computing device 302 includes a qubit assembly 352 and a control and measurement system 304. The qubit assembly includes multiple qubits, e.g., qubit 306, that are used to perform algorithmic operations or quantum computations. While the qubits shown in FIG. 3 are arranged in a rectangular array, this is a schematic depiction and is not intended to be limiting. The qubit assembly 352 also includes adjustable coupling elements, e.g., coupler 308, that allow for interactions between coupled qubits. In the schematic depiction of FIG. 3, each qubit is adjustably coupled to each of its four adjacent qubits by means of respective coupling elements. However, this is an example arrangement of qubits and couplers and other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 302 included in the example computer 300 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits may be realized via superconducting qubits or semi-conducting qubits, e.g., superconducting transmon states. As another example, in a NMR quantum computer the qubits may be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits, e.g., to implement a quantum algorithm such as a quantum principle component algorithm. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), and gates involving three or more qubits, e.g., Toffoli gates. The quantum logic gates can be implemented by applying control signals 310 generated by the control and measurement system 304 to the qubits and to the couplers.

For example, in some implementations the qubits in the qubit assembly 352 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 310 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 310. The measurements cause readout signals 312 representing measurement results to be communicated back to the measurement and control system 304. The readout signals 312 may include RF, microwave, or optical signals depending on the physical scheme for the quantum computing device and/or the qubits. For convenience, the control signals 310 and readout signals 312 shown in FIG. 3 are depicted as addressing only selected elements of the qubit assembly (i.e. the top and bottom rows), but during operation the control signals 310 and readout signals 312 can address each element in the qubit assembly 352.

The control and measurement system 304 is an example of a classical computer system that can be used to perform various operations on the qubit assembly 352, as described above, as well as other classical subroutines or computations. The control and measurement system 304 includes one or more classical processors, e.g., classical processor 314, one or more memories, e.g., memory 316, and one or more I/O units, e.g., I/O unit 318, connected by one or more data buses. The control and measurement system 304 can be programmed to send sequences of control signals 310 to the qubit assembly, e.g. to carry out a selected series of quantum gate operations, and to receive sequences of readout signals 312 from the qubit assembly, e.g. as part of performing measurement operations.

The processor 314 is configured to process instructions for execution within the control and measurement system 304. In some implementations, the processor 314 is a single-threaded processor. In other implementations, the processor 314 is a multi-threaded processor. The processor 314 is capable of processing instructions stored in the memory 316.

The memory 316 stores information within the control and measurement system 304. In some implementations, the memory 316 includes a computer-readable medium, a volatile memory unit, and/or a non-volatile memory unit. In some cases, the memory 316 can include storage devices capable of providing mass storage for the system 304, e.g. a hard disk device, an optical disk device, a storage device that is shared over a network by multiple computing devices (e.g., a cloud storage device), and/or some other large capacity storage device.

The input/output device 318 provides input/output operations for the control and measurement system 304. The input/output device 318 can include D/A converters, A/D converters, and RF/microwave/optical signal generators, transmitters, and receivers, whereby to send control signals 310 to and receive readout signals 312 from the qubit assembly, as appropriate for the physical scheme for the quantum computer. In some implementations, the input/output device 318 can also include one or more network interface devices, e.g., an Ethernet card, a serial communication device, e.g., an RS-232 port, and/or a wireless interface device, e.g., an 802.11 card. In some implementations, the input/output device 318 can include driver devices configured to receive input data and send output data to other external devices, e.g., keyboard, printer and display devices.

Although an example control and measurement system 304 has been depicted in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The example system 300 also includes an example classical processor 350. The classical processor 350 can be used to perform classical computation operations described in this specification according to some implementations, e.g., the classical machine learning methods described herein.

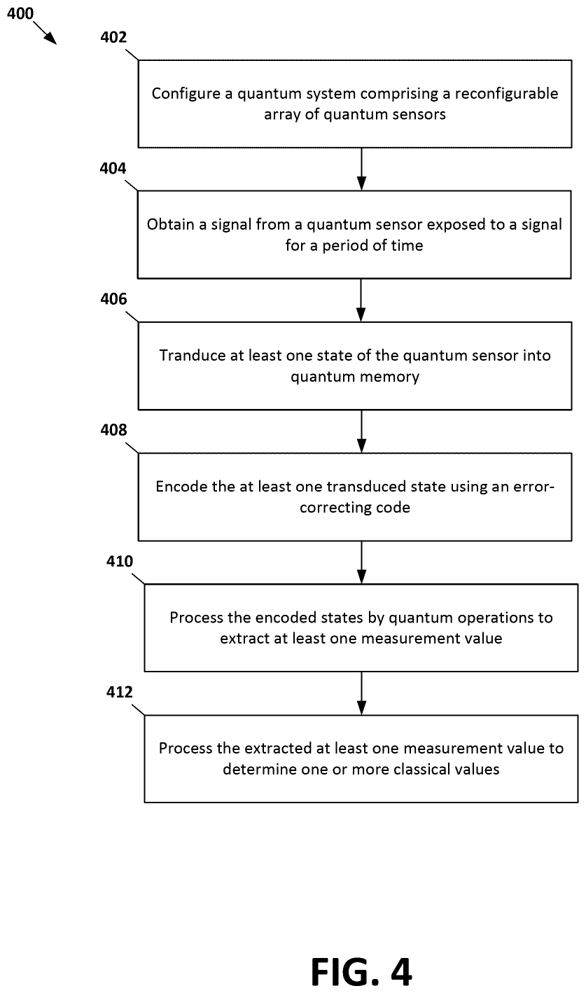

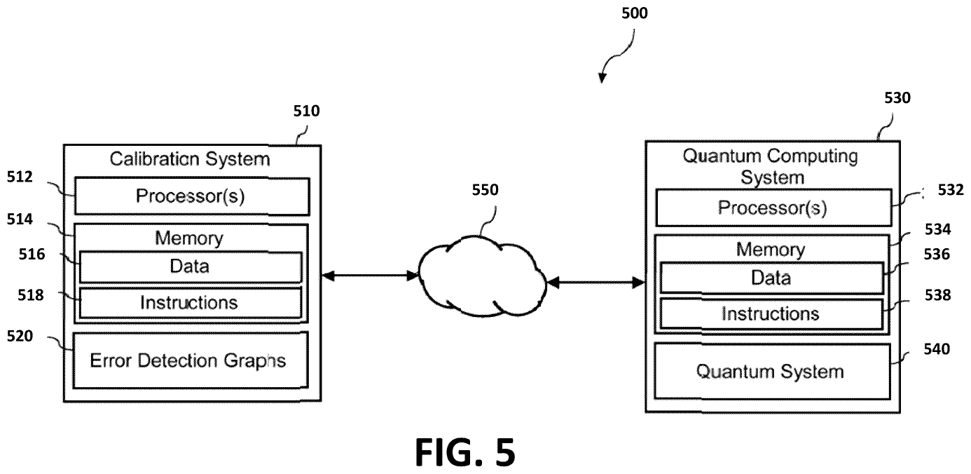

FIG. 4 depicts a flow chart of a method according to example embodiments of the present disclosure. The operations may be implemented by a quantum and/or classical computing system. For instance, the operations may be implemented by the computing system 500 (e.g., one or more processors 512 of the computing system) depicted in FIG. 5. FIG. 4 illustrates operations performed in a particular order for purposes of illustration and discussion. Those of ordinary skill in the art, using the disclosures provided herein, will understand the various operations of any of the methods described herein can be adapted, modified, rearranged, omitted, include steps not illustrated, and/or expanded in various ways without deviating from the scope of the present disclosure.

At (402), the method 400 can include configuring a quantum system including a reconfigurable array of quantum sensors. A quantum sensor can be any quantum system capable of controlled interaction and readout that may be interfaced to another quantum system coherently. This arrangement may be regular, such as in a 1D, 2D, or 3D lattice, or irregular depending on the optimal configuration for the given task. The scales may range from very small (e.g. nanometers) to very large (miles, interplanetary, or intergalactic using quantum entanglement connections). Each individual element in the array may be chosen custom or tuned custom for the design. For example, neutral (Rydberg) atoms can be tuned to frequencies ranging from MHz to THz to optical absorption. This array may be combined with optical or general electromagnetic control elements to collect signals in ideal configurations collecting multiple copies either simultaneously or in sequence after transduction.

At (404), the method 400 can include obtaining a signal from a quantum sensor exposed to a signal for a period of time. For instance, the sensor can be exposed to the desired signal for the prescribed time and the signal is collected in the quantum sensor.

At (406), the method 400 can include transducing at least one state of the quantum sensor into quantum memory. For instance, the quantum state of the sensor can be transferred into quantum memory, which may be of a different or similar physical substrate as the sensor. This process is termed transduction.

At (408), the method 400 can include encoding the at least one transduced state using an error-correcting code. For instance, the transduced state can be encoded into quantum memory using an error correcting code of sufficient quality. This code may range from the identity (physical encoding) to advanced high distance or rate encoding designed for long term storage based on the required lifetime and quality of the state.

The above process of collection, transduction, and encoding is repeated as needed until a sufficient number of copies of the state are collected for processing. This may be as few as two states for minimal quantum memory processing, where the steps are repeated destructively without growing the memory beyond some constant number of copies k.

At (410), the method 400 can include processing the encoded states by quantum operations to extract at least one measurement value. For instance, the states in memory can be processed using quantum computation in combination with the quantum memory and measurement to extract the desired data from the stored states. This may range from Bell measurements, to generalized Bell measurements, to shadow tomography, multiplicative weight updates, or more general quantum measurements across one or more copies stored in memory.

At (412), the method 400 can include processing the extracted at least one measurement value to determine one or more classical values. For instance, the extracted measurements can be stored classically and processed to determine the values of interest for the sensor.

FIG. 5 depicts a block diagram of an example computing system 500 that can be used to implement the systems and methods according to example embodiments of the present disclosure, such as the method 400 discussed with reference to FIG. 4. The system 500 includes a classical computing system 510 and a quantum computing system 530 that are communicatively coupled over a network 550. One or more aspects of any of the methods described herein can be implemented on the classical computing system 510 and/or the quantum computing system 530.

The classical computing system 510 can include any type of computing device (e.g., classical computing device). The classical computing system 510 includes one or more processors 512 and a memory 514. The one or more processors 512 can include any suitable processing device (e.g., a processor core, a microprocessor, an ASIC, a FPGA, a controller, a microcontroller, etc.) and can be one processor or a plurality of processors that are operatively connected. The memory 514 can include one or more non-transitory computer-readable storage mediums, such as RAM, ROM, EEPROM, EPROM, flash memory devices, magnetic disks, etc., and combinations thereof. The memory 514 can store data 516 (e.g., qubit parameters, measurements, etc.) and instructions 518 which are executed by the processor 512 to cause the classical computing system 510 to perform operations, such as one or more aspects of any of the method disclosed herein. The classical computing system 510 can be configured to process error information (e.g., error detection graphs 520) obtained by measuring outputs of a quantum system (e.g., quantum system 540) to identify errors in quantum computations according to example embodiments of the present disclosure.

The quantum computing system 530 includes one or more processors 532 and a memory 534. The one or more processors 532 can include suitable processing device (e.g., a processor core, a microprocessor, an ASIC, a FPGA, a controller, a microcontroller, etc.) and can be one processor or a plurality of processors that are operatively connected. The memory 534 can include one or more non-transitory computer-readable storage mediums, such as RAM, ROM, EEPROM, EPROM, flash memory devices, magnetic disks, etc., and combinations thereof. The memory 534 can store data 536 and instructions 538 which are executed by the processor 532 to cause the quantum computing system 530 to perform operations, such as implementation of a quantum circuit having one or more quantum gates on a quantum system 540 having a plurality of qubits and obtaining associated measurements (e.g., error detection graphs 520). The quantum computing system 530 can be similar to the quantum computing system discussed and described with reference to FIG. 1. Other suitable quantum computing systems can be used without deviating from the scope of the present disclosure.

The network 550 can be any type of communications network, such as a local area network (e.g., intranet), wide area network (e.g., Internet), or some combination thereof and can include any number of wired or wireless links. In general, communication over the network 550 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). In some implementations, the network 550 may be omitted such that the classical computing system 510 is in direct signal communication with quantum computing system 530.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs (e.g., one or more modules of digital and/or quantum computer program instructions encoded on a tangible non-transitory storage medium for execution by, or to control the operation of, data processing apparatus). The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit (i.e., a system that defines the unit of quantum information). It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A computer-implemented method, the method including:
configuring a quantum system including a reconfigurable array of quantum sensors;
obtaining a signal from a quantum sensor of the reconfigurable array of quantum sensors, the quantum sensor exposed to a signal for a period of time;
transducing at least one state of the quantum sensor into quantum memory;
encoding the at least one transduced state using an error-correcting code;
processing the encoded states by quantum operations to extract at least one measurement value; and
processing the extracted at least one measurement value to determine one or more classical values.

2. The method of claim 1, wherein the reconfigurable array of quantum sensors includes one of a 1D lattice, a 2D lattice, a 3D lattice, or an irregular configuration.

3. The method of claim 1, wherein the reconfigurable array includes one or more Rydberg atoms having adjustable frequencies.

4. The method of claim 1, wherein the reconfigurable array includes mixed sensor media across the reconfigurable array, the mixed sensor media including one or more of an atom, a nitrogen vacancy, a silicon vacancy, a mechanical resonator, an optical resonator, an optical cavity, an electromagnetic cavity, or a superconducting sensor.

5. The method of claim 1, wherein the quantum system includes one or more control elements for configuring the quantum sensor for collecting the signal.

6. The method of claim 1, wherein the quantum memory includes a different substrate from the quantum sensor.

7. The method of claim 1, wherein the quantum operations for processing the encoded states to extract at least one measurement value include one or more of Bell measurements, generalized Bell measurements, shadow tomography, multiplicative weight updates, or quantum measurements across one or more copies of the encoded states.

8. The method of claim 1, wherein the one or more classical values relate to one or more of gravity detection, mineral discovery, baseline interferometry, detection of axions, supplementation of data in machine learning models addressing quantum systems, detection schemes on quantum communication networks, or data prediction.

9. The method of claim 1, wherein the quantum sensor observes a target system while exposed to the signal, and wherein the quantum sensor is dependent on a parameter of interest reflective of a state of the target system while observing the target system.

10. The method of claim 9, wherein the target system includes one or more of an unknown metabolite and wherein the parameter of interest includes a structure of the unknown metabolite.

11. The method of claim 9, wherein the parameter of interest includes one or more of an amount, a distribution, a type, or a material property of matter in an interior of the target system.

12. The method of claim 9, wherein the quantum sensor includes a plurality of quantum sensors that probe the target system in parallel.

13. The method of claim 1, wherein the quantum sensor includes a at least one of nitrogen vacancy in diamond, a hyper-polarized spin in gases, a nuclear spin of chemical specials in a solution, or a cavity mode for sensing photonic states or detecting exotic particles.

14. The method of claim 1, wherein encoding the at least one transduced state includes encoding the at least one transduced state in a quantum buffer.

15. The method of claim 14, wherein the quantum buffer includes one or more of a superconducting computer including one or more superconducting qubits, an ion trap quantum computer, or a quantum computer that includes photonic qubits in a cluster state.

16. The method of claim 14, wherein the quantum sensor and the quantum buffer operate at different energy scales.

17. A quantum system, including:
a reconfigurable array of quantum sensors;
a quantum memory;
one or more processors, and
one or more non-transitory, computer-readable media storing instructions that, when implemented, cause the one or more processors to perform operations, the operations including:
obtaining a signal from a quantum sensor of the reconfigurable array of quantum sensors, the quantum sensor exposed to a signal for a period of time;
transducing at least one state of the quantum sensor into the quantum memory;
encoding the at least one transduced state using an error-correcting code;
processing the encoded states by quantum operations to extract at least one measurement value; and
processing the extracted at least one measurement value to determine one or more classical values.

18. The quantum system of claim 17, wherein the quantum sensor observes a target system while exposed to the signal, and wherein the quantum sensor is dependent on a parameter of interest reflective of a state of the target system while observing the target system.

19. The quantum system of claim 17, wherein the quantum buffer includes one or more of a superconducting computer including one or more superconducting qubits, an ion trap quantum computer, or a quantum computer that includes photonic qubits in a cluster state.

20. One or more non-transitory, computer-readable media storing instructions that, when implemented, cause one or more processors to perform operations, the operations including:
configuring a quantum system including a reconfigurable array of quantum sensors;
obtaining a signal from a quantum sensor exposed to a signal for a period of time;
transducing at least one state of the quantum sensor into quantum memory;
encoding the at least one transduced state using an error-correcting code;
processing the encoded states by quantum operations to extract at least one measurement value; and
processing the extracted at least one measurement value to determine one or more classical values.
